(19) United States
(12) Patent Application Publication
(10) Pub. No.: US 2023/0079698 A1
(43) Pub. Date: Mar. 16, 2023

(54) Data Storage Devices, Systems, and Related Methods to Determine Writing Fragmentation Levels of Memory Devices

(71) Applicant: Western Digital Technologies, Inc., San Jose, CA (US)

(72) Inventors: Amir SHAHARABANY, Kochav Yair (IL); Adi FOGEL, Tel Aviv (IL); Nadav SOBER, Shoam (IL)

(21) Appl. No.: 17/476,955

(22) Filed: Sep. 16, 2021

(51) Int. Cl. G06F 3/06

(52) U.S. Cl. CPC G06F 3/064; G06F 3/0659; G06F 3/0619; G06F 3/0679

(57) ABSTRACT

Aspects of the present disclosure generally relate to data storage devices, systems, and related methods that determine writing fragmentation levels of memory devices, such as memory devices of solid-state drives (SSDs). In one aspect, a controller of a data storage device is configured to determine a plurality of valid counts of a plurality of blocks of one or more memory devices, and arrange the plurality of valid counts of the plurality of blocks into a plurality of valid count groupings. The plurality of valid counts is arranged into a histogram having the plurality of block counts and the plurality of valid count groupings. In one aspect, the controller is configured to multiply the plurality of block counts by a plurality of assigned weights to determine a plurality of writing fragmentation values. In one aspect, the controller is configured to determine a writing fragmentation level.

### BACKGROUND OF THE DISCLOSURE

### Field of the Disclosure

Aspects of the present disclosure generally relate to data storage devices, systems, and related methods that determine writing fragmentation levels of memory devices, such as memory devices of solid-state drives (SSDs).

### Description of the Related Art

Fragmentation of data storage involves the discontinuous and/or non-sequential storage of data in blocks. Fragmentation can occur during writing operations, and fragmentation can hinder device performance at least with respect to processing efficiency and operation time. Fragmentation can also be more problematic than reduced overall storage availability. That is, device performance can be hindered more if fragmentation is higher even if overall storage availability is higher.

Efforts to address fragmentation are complex, time-consuming, and/or relatively ineffective, thereby hindering device performance.

Therefore, there is a need in the art for data storage devices that practically, simply, efficiently, and effectively determine write fragmentation levels of memory devices.

### SUMMARY OF THE DISCLOSURE

Aspects of the present disclosure generally relate to data storage devices, systems, and related methods that determine writing fragmentation levels of memory devices, such as memory devices of solid-state drives (SSDs). In one aspect, a controller of a data storage device is configured to determine a plurality of valid counts of a plurality of blocks of one or more memory devices, and arrange the plurality of valid counts of the plurality of blocks into a plurality of valid count groupings. The plurality of valid counts is arranged into a histogram having the plurality of block counts and the plurality of valid count groupings. In one aspect, the controller is configured to multiply the plurality of block counts by a plurality of assigned weights to determine a plurality of writing fragmentation values. In one aspect, the controller is configured to sum together the plurality of writing fragmentation values to determine a fragmentation sum, sum together the plurality of block counts to determine a count sum, and divide the fragmentation sum by the count sum to determine a writing fragmentation level. One or more of the plurality of valid counts, the histogram, the plurality of block counts, the plurality of valid count groupings, the plurality of assigned weights, the plurality of writing fragmentation values, the fragmentation sum, the count sum, and/or the writing fragmentation level are part of a fragmentation report that is generated by the controller.

In one embodiment, a data storage device includes one or more memory devices that include a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings to determine a plurality of block counts corresponding to the plurality of valid count groupings. The controller is configured to multiply the plurality of block counts by a plurality of assigned weights to determine a plurality of writing fragmentation values.

In one embodiment, a data storage device includes one or more memory devices that include a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings of a histogram to determine a plurality of block counts corresponding to the plurality of valid count groupings. Each block count of the plurality of block counts is a number of blocks having a valid count of the plurality of valid counts that is within a respective valid count grouping of the plurality of valid count groupings. The controller is configured to multiply the plurality of block counts by a plurality of assigned weights to determine a plurality of writing fragmentation values, and sum together the plurality of writing fragmentation values to determine a fragmentation sum. The controller is configured sum together the plurality of block counts to determine a count sum, and divide the fragmentation sum by the count sum to determine a writing fragmentation level.

In one embodiment, a data storage device includes one or more memory storage means that includes a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings to determine a plurality of block counts corresponding to the plurality of valid count groupings. The controller is configured to multiply the plurality of block counts by a plurality of assigned weights to determine a plurality of writing fragmentation values.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram view of a storage system in which a data storage device may function as a storage device for a host device, according to one implementation.

FIG. 2 is a schematic block diagram view of a method of determining writing fragmentation levels of memory devices, according to one implementation.

FIG. 3A is a schematic graphical view of a first histogram, according to one implementation.

FIG. 3B is a schematic graphical view of a second histogram, according to one implementation.

FIG. 4 is a schematic tabular view of a table, according to one implementation.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure generally relate to data storage devices, systems, and related methods that determine writing fragmentation levels of memory devices, such as memory devices of solid-state drives (SSDs). In one aspect, a controller of a data storage device is configured to determine a plurality of valid counts of a plurality of blocks of one or more memory devices, and arrange the plurality of valid counts of the plurality of blocks into a plurality of valid count groupings. The plurality of valid counts is arranged into a histogram having the plurality of block counts and the plurality of valid count groupings. In one aspect, the controller is configured to multiply the plurality of block counts by a plurality of assigned weights to determine a plurality of writing fragmentation values. In one aspect, the controller is configured to sum together the plurality of writing fragmentation values to determine a fragmentation sum, sum together the plurality of block counts to determine a count sum, and divide the fragmentation sum by the count sum to determine a writing fragmentation level. One or more of the plurality of valid counts, the histogram, the plurality of block counts, the plurality of valid count groupings, the plurality of assigned weights, the plurality of writing fragmentation values, the fragmentation sum, the count sum, and/or the writing fragmentation level are part of a fragmentation report that is generated by the controller.

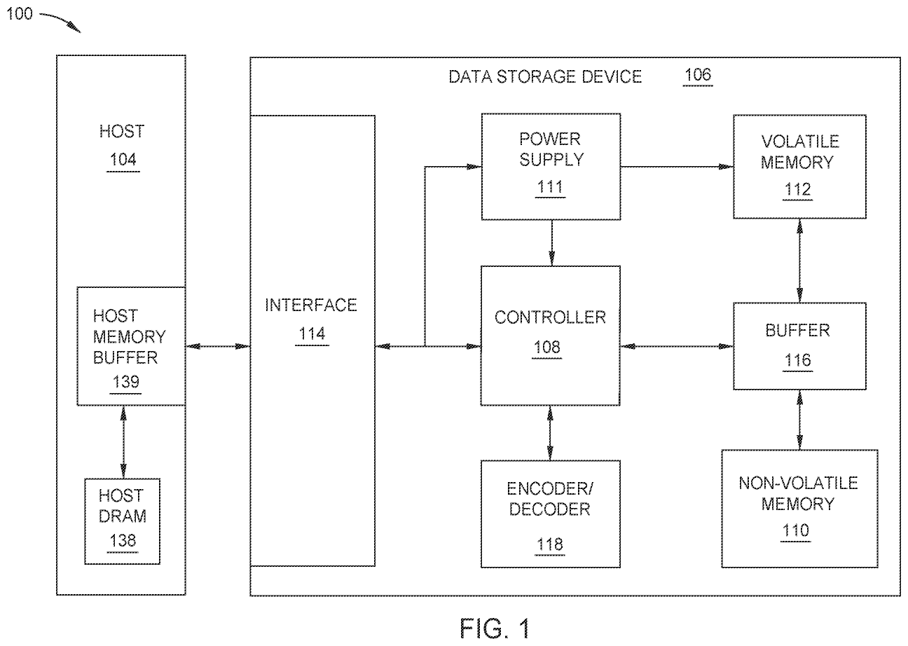

FIG. 1 is a schematic block diagram view of a storage system 100 in which a data storage device 106 may function as a storage device for a host device 104, according to one implementation.

The host device 104 is in communication with the data storage device 106. As an example, the host device 104 may use a non-volatile memory (NVM) 110 included in the data storage device 106 to store and retrieve data. The host device 104 includes a host dynamic random-access memory (DRAM) 138. In one embodiment, which can be combined with other embodiments, the storage system 100 may include a plurality of storage devices, such as one or more additional data storage devices 106, which may operate as a storage array. As an example, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As shown in FIG. 1, the host device 104 can communicate with the data storage device 106 using an interface 114. The interface 114 can communicate with a host memory buffer (HMB) 139 of the host device 104. The host device 104 can include any of a wide range of devices, including computer servers, network-attached storage (NAS) units, desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The data storage device 106 includes a controller 108, the NVM 110, a power supply 111, a volatile memory 112, the interface 114, and a write buffer 116. The controller 108 is coupled to the one or more memory devices of the NVM 110 and/or the volatile memory 112 through the write buffer 116. The data storage device 106 may include additional components not shown in FIG. 1 for the sake of clarity. For example, the data storage device 106 may include a printed circuit board (PCB) to which components of the data storage device 106 are mechanically attached. The PCB includes electrically conductive traces that electrically interconnect components of the data storage device 106 or the like. In one embodiment, which can be combined with other embodiments, the physical dimensions and connector configurations of the data storage device 106 conform to one or more standard form factors. Some example standard form factors include, but are not limited to, a 3.5″ data storage device (e.g., a hard disk drive (HDD) or solid-state drive (SSD)), a 2.5″ data storage device, a 1.8″ data storage device, a peripheral component interconnect (PCI), PCI-extended (PCI-X), PCI Express (PCIe) (e.g., PCIe x1, x4, x8, x16, PCIe Mini Card, MiniPCI, etc.). In one embodiment, which can be combined with other embodiments, the data storage device 106 is directly coupled (e.g., directly soldered or plugged into a connector) to a motherboard of the host device 104.

The interface 114 can include one or both of a data bus for exchanging data with the host device 104 and a control bus for exchanging commands with the host device 104. The interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. The interface 114 (e.g., the data bus, the control bus, or both) is electrically connected to the controller 108, providing an electrical connection between the host device 104 and the controller 108, and facilitating allowing data to be exchanged between the host device 104 and the controller 108. The electrical connection of interface 114 may also facilitate permitting the data storage device 106 to receive power from the host device 104. As an example, as shown in FIG. 1, the power supply 111 can receive power from the host device 104 using the interface 114.

The NVM 110 includes one or more memory devices or memory units. The NVM 110 may be configured to store and/or retrieve data. For instance, a memory device of NVM 110 may receive data and a message from controller 108 that instructs the memory device to store the data. Similarly, the memory unit may receive a message from the controller 108 that instructs the memory device to retrieve data. Each of the memory devices may be referred to as a die. In one embodiment, which can be combined with other embodiments, the NVM 110 includes a plurality of dies (e.g., a plurality of memory devices). Each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

Each memory unit can include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 can include a plurality of flash memory devices or memory units. The flash memory devices of the NVM 110 can include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices of the NVM 110 at the page level and erase data from NVM flash memory devices of the NVM 110 at the block level.

Each of the one or more memory devices of the NVM 110 includes a plurality of blocks in which data can be stored (e.g., written to). The controller 108 is configured to write data to and/or read data from the plurality of blocks of the NVM 110 in response to a message received by the controller 108 from the host device 104.

The power supply 111 provides power to one or more components of the data storage device 106. When operating in a standard mode, the power supply 111 may provide power to one or more components using power provided by an external device, such as the host device 104. The power supply 111 may provide power to the one or more components using power received from the host device 104 using the interface 114. In one embodiment, which can be combined with other embodiments, the power supply 111 includes one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. The amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components can also increase.

The volatile memory 112 may be used by controller 108 to store information. Volatile memory 112 may include one or more memory devices. In one embodiment, which can be combined with other embodiments, the controller 108 uses the volatile memory 112 as a cache. The controller 108 may store cached information in volatile memory 112 until the cached information is written to the NVM 110. As shown in FIG. 1, the volatile memory 112 can consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)).

The controller 108 may manage one or more operations of the data storage device 106. For instance, controller 108 may manage the reading of data from and/or the writing of data to the NVM 110. In one embodiment, which can be combined with other embodiments, when the data storage device 106 receives a write command from the host device 104, the controller 108 initiates a data storage command to store data to the NVM 110 and monitor the progress of the data storage command. The controller 108 may determine at least one operational characteristic of the storage system 100 and store the at least one operational characteristic in the NVM 110.

The data storage device 106 includes an encoder/decoder 118. In one example, which can be combined with other examples, the encoder/decoder 118 is a low density parity code (LDPC) encoder/decoder. In one example, which can be combined with other examples, the encoder/decoder 118 is an Exclusive-Or (XOR) encoder/decoder. The encoder/decoder 118 may include an internal memory to hold several matrices that include a plurality of error correction codes (ECC). The one or more matrices of the internal memory of the encoder/decoder 118 may allow for fast switching between matrices to avoid any firmware (FW) intervention or performance loss due to the time to switch between matrices. In one embodiment, which can be combined with other embodiments, when the data storage device 106 receives a write command from the host device 104, the controller 108 temporarily stores the data associated with the write command in the internal memory of the encoder/decoder 118, in the volatile memory 112, or in the write buffer 116 before sending the data to the NVM 110 to be written.

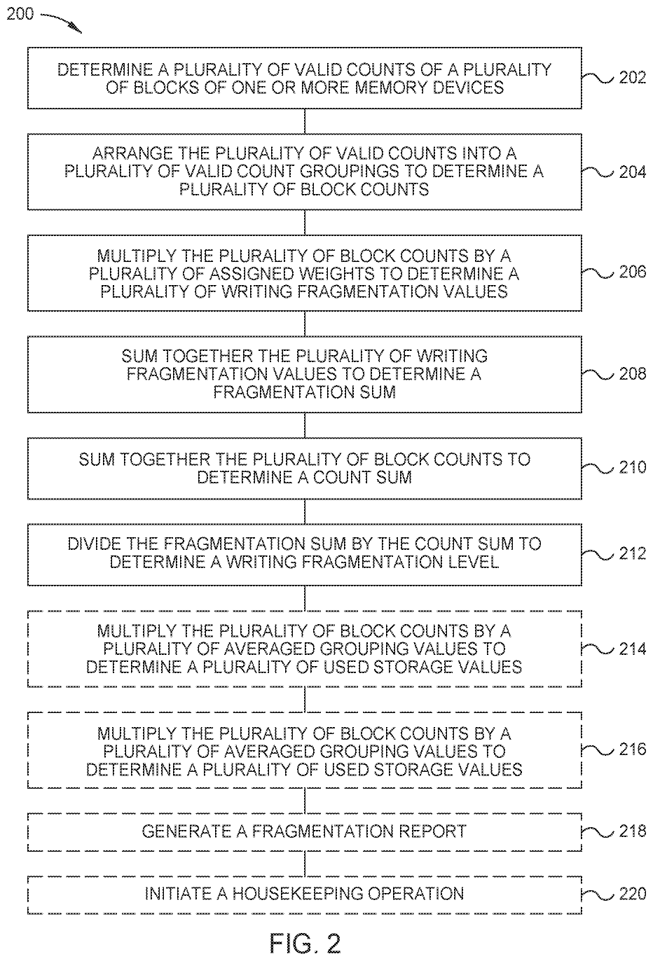

FIG. 2 is a schematic block diagram view of a method 200 of determining writing fragmentation levels of memory devices, according to one implementation. For purposes of clarity, the operations 202-220 of the method 200 are described herein in relation to the storage system 100. The present disclosure contemplates that the operations 202-220 of the method 200 can be conducted in relation to other storage systems. In one embodiment, which can be combined with other embodiments, the controller 108 is configured to conduct the operations 202-220 of the method 200. In one embodiment, which can be combined with other embodiments, the controller 108 is configured to conduct the operations 202-220 by instructing other components (such as the NVM 110, the write buffer 116, and/or the interface 114) of the data storage device 106 to carry out the operations 202-220.

Operation 202 includes determining a plurality of valid counts of a plurality of blocks of one or more memory devices. The plurality of blocks have data written therein as a result of a writing operation that was previously conducted. Each valid count of the plurality of valid counts is a used data storage percentage for a respective block of the plurality of blocks. Each valid count of the plurality of valid counts can indicate a number of valid flash management units (FMU's) in the respective block. The determining of a plurality of valid counts of operation 202 is part of a read operation conducted on the NVM 110 using the write buffer 116 and initiated using the controller 108.

Operation 204 includes arranging the plurality of valid counts of the plurality of blocks into a plurality of valid count groupings to determine a plurality of block counts corresponding to the plurality of valid count groupings. Each block count of the plurality of block counts is a number of blocks having a valid count of the plurality of valid counts that is within a respective valid count grouping of the plurality of valid count groupings. The plurality of valid counts is arranged into a histogram having the plurality of block counts and the plurality of valid count groupings.

The plurality of valid count groupings includes a lower end grouping of 0%, an upper end grouping of 100%, and a plurality of intervening groupings. The plurality of intervening groupings are intervals between 0% and 100%. In one embodiment, which can be combined with other embodiments, at least some of the intervals are 10% intervals. The present disclosure contemplates that other percentages may be used for the intervals. In one embodiment, which can be combined with other embodiments, at least some of the intervals are 5% intervals or 3% intervals. In one embodiment, which can be combined with other embodiments, the plurality of valid count groupings includes an intervening hybrid grouping. In one example, which can be combined with other examples, the intervening hybrid grouping ranges from 32.5% to 33.5%. In one example, which can be combined with other examples, the intervening hybrid grouping is 33.0%.

The plurality of intervening groupings includes an intermediate intervening grouping. In one embodiment, which can be combined with other embodiments, the intermediate intervening grouping is a median of the plurality of intervening groupings. In one embodiment, which can be combined with other embodiments, the intermediate intervening grouping ranges from 41% to 50%. In one embodiment, which can be combined with other embodiments, the intermediate intervening grouping ranges from 51% to 60%, from 46% to 50%, or from 46% to 55%.

Each block count of the plurality of block counts is a number of blocks having a valid count of the plurality of valid counts that is within a respective valid count grouping of the plurality of valid count groupings.

Operation 206 includes multiplying the plurality of block counts by a plurality of assigned weights to determine a plurality of writing fragmentation values. The plurality of assigned weights includes a first minimal weight assigned to the lower end grouping, a second minimal weight assigned to the upper end grouping, and a maximal weight assigned to the median intervening grouping. The plurality of assigned weights includes a first set of intervening weights assigned to a first subset of the plurality of intervening groupings between the lower end grouping and the median intervening grouping. The first set of intervening weights decrease in value in a direction from the maximal weight and toward to the first minimal weight. The plurality of assigned weights includes a second set of intervening weights assigned to a second subset of the plurality of intervening groupings between the upper end grouping and the median intervening grouping. The second set of intervening weights decrease in value in a direction from the maximal weight and toward the second minimal weight.

The first minimal weight is zero, the second minimal weight is zero, and the maximal weight is 100. In one embodiment, which can be combined with other embodiments, the first set of intervening weights range from 5 to 90, and the second set of intervening weights range from 5 to 90.

Operation 208 includes summing together the plurality of writing fragmentation values to determine a fragmentation sum.

Operation 210 includes summing together the plurality of block counts to determine a count sum.

Operation 212 includes dividing the fragmentation sum by the count sum to determine a writing fragmentation level of the one or more memory devices. In one embodiment, which can be combined with other embodiments, the one or more memory devices are part of the NVM 110. The plurality of writing fragmentation values and the writing fragmentation level indicate a degree of fragmentation for the data written into the blocks of the one or more memory devices. The data written into the blocks can be part of a file and/or an application that is used in relation to the host device 104.

Optional operation 214 includes multiplying the plurality of block counts by a plurality of averaged grouping values corresponding to the plurality of valid count groupings to determine a plurality of used storage values. Each averaged grouping value of the plurality of averaged grouping values is determined by summing together a lower end of a respective valid count grouping and an upper end of the respective valid count grouping to determine a grouping sum, and dividing the grouping sum by a factor of two. The present disclosure contemplates that one or more of the plurality of valid count groupings, the plurality of assigned weights, and/or the plurality of averaged grouping values can be predetermined and stored, such as stored in the volatile memory 112 or a memory of the controller 108.

Optional operation 216 includes summing together the plurality of used storage values to determine a used storage level. The plurality of used storage values and the used storage level indicate a degree of used storage for the blocks of the one or more memory devices.

Optional operation 218 includes generating a fragmentation report. The fragmentation report can be used by the data storage device 106, and/or can be transmitted to the host device 104. The controller 108 transmits the fragmentation report to the host device 104 using the interface 114. In one embodiment, which can be combined with other embodiments, the fragmentation report is merged with an existing host report that is transmitted to the host device 104, facilitating enhanced efficiency and device performance.

The fragmentation report can include a write amplification factor (WAF) of one or more writing operations that were conducted prior to the method 200 being conducted, in addition to or alternatively to one or more writing fragmentation levels of the one or more writing operations. In such an embodiment, the host device 104 and the data storage device 106 are part of an enterprise environment. In one embodiment, which can be combined with other embodiments, the fragmentation report includes an alert if the WAF is within a WAF range. In one embodiment, which can be combined with other embodiments, the WAF range is 25% or higher. The fragmentation report can correspond to a workload having one or more writing operations. The fragmentation report can indicate to the host device 104 which workload(s) can be altered to facilitate reduced data fragmentation and enhanced device performance.

The fragmentation report includes an alert if the writing fragmentation level is within a fragmentation range. In one embodiment, which can be combined with other embodiments, the fragmentation range is 25.0% or higher. The fragmentation report indicates an offset to the write buffer 116. The fragmentation report can include the first histogram 350 and/or the information included therein, the second histogram 350 and/or the information included therein, and/or the table 400 and/or the information included therein.

Optional operation 220 includes initiating a housekeeping operation for the one or more memory devices if the writing fragmentation level is at or above a threshold level. In one embodiment, which can be combined with other embodiments, the threshold level is 25.0%. The housekeeping operation can be referred to as a garbage collection operation, and can include one or more of defragmenting data, discarding data, and/or cleaning up data. The housekeeping operation can involve deleting data, or deleting data from blocks and rewriting the data into other blocks to defragment the data. The house keeping operation targets and prioritizes blocks that fall within lower valid count groupings (such as valid count groupings that are less than 81%) to open such blocks up for subsequent writing operations while facilitating reduced writing fragmentation for the subsequent writing operations. The lower the valid count grouping (other than the lower end grouping) that a particular block falls within, the more the housekeeping operation prioritizes that particular block. The controller 108 can initiate the housekeeping operation in response to a command message received from the host device 104. In one embodiment, which can be combined with other embodiments, the controller 108 initiates the housekeeping operation without a command message from the host device 104. In one example, which can be combined with other examples, the controller 108 schedules the housekeeping operation using priorities without receiving the command message from the host device 104. The housekeeping operation can be generally enabled for the controller 108. The present disclosure contemplates that the controller 108 can send a message to the host device 104 to initiate the housekeeping operation.

The housekeeping operation may not be conducted on an entirety of the data storage device 106, and may be conducted on a data total of 2 Gigabytes. The housekeeping operation, using the data total, can use the fragmentation report to calculate a number of blocks to defragment, determine which blocks to defragment, and a defragmentation time to defragment the blocks.

The blocks falling within the lower end grouping (of 0%) are omitted from the house keeping operation. An autofree operation is conducted on the blocks falling within the lower end grouping (of 0%). Blocks falling within the upper end grouping (of 100%) are omitted from the subsequent writing operations.

The method 200 can also include an optional operation that includes repeating operations 202 and 204, and determining if a block count corresponding to an intervening grouping has increased. The intervening grouping ranges from 31% to 40%. A number of one or more hybrid blocks identified is a number by which the intervening grouping has increased. Such blocks are identified as hybrid blocks because such blocks are 1 bit rather than 3 bit blocks, and are completely full of data at a 33% indicated valid count. Upon the identification of the one or more hybrid blocks, the method 200 can include initiating a housekeeping operation for the one or more hybrid blocks, such as to defragment the one or more hybrid blocks. The identification of the one or more hybrid blocks can be part of a qualification operation that determines if the proper number of hybrid blocks are present, such as to determine if operation of the data storage device 106 is complying with one or more hybrid block disable criteria.

The method 200 can also include an operational operation that includes conducting a writing operation following the generation of the fragmentation report. Using the fragmentation report, the host device 104 can determine which blocks have a relatively low valid count and calculate a buffer during which the writing operation is conducted for the blocks having the relatively low valid count.

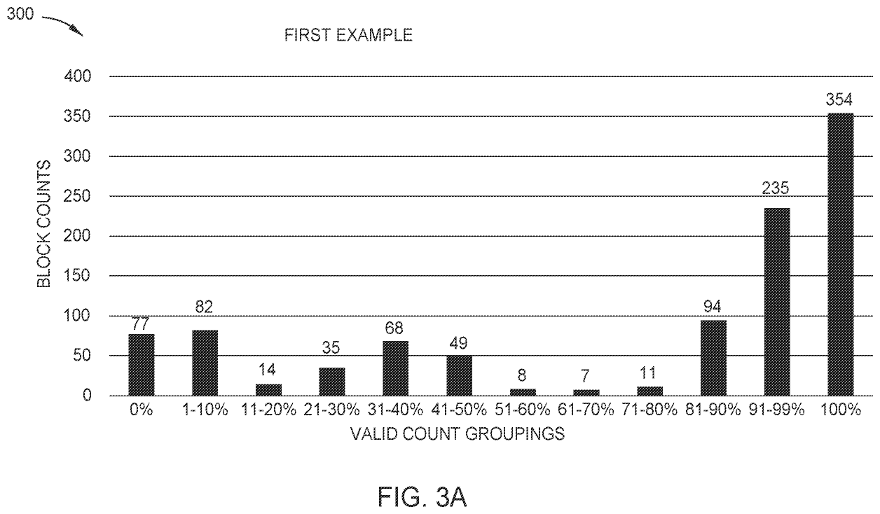

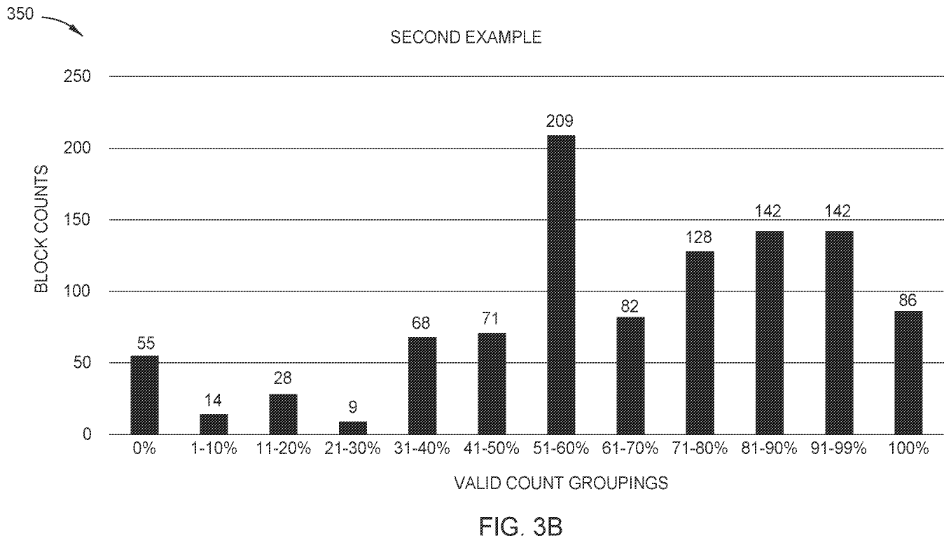

FIG. 3A is a schematic graphical view of a first histogram 300, according to one implementation. The first histogram 300 is generated according to a first example using the method 200 shown in FIG. 2. FIG. 3B is a schematic graphical view of a second histogram 350, according to one implementation. The second histogram 350 is generated according to a second example using the method 200 shown in FIG. 2. The first example and the second example can result from the method 200 conducted on the same memory device, each after two different write operations are conducted. The first example and the second example can result from the method 200 conducted on two different memory devices. In the implementation shown in FIG. 2 the first example and the second example result from the same memory device having different fragmentation levels.

The first and second histograms 300, 350 each includes the plurality of block counts plotted on a vertical axis, and the plurality of valid count groupings. The plurality of valid count groupings in each histogram 300, 350 includes a lower end grouping of 0%, an upper end grouping of 100%, an intervening grouping ranging from 1% to 10%, an intervening grouping ranging from 11% to 20%, an intervening grouping ranging from 21% to 30%, an intervening grouping ranging from 31% to 40%, an intervening grouping ranging from 41% to 50%, an intervening grouping ranging from 51% to 60%, an intervening grouping ranging from 61% to 70%, an intervening grouping ranging from 71% to 80%, an intervening grouping ranging from 81% to 90%, and an intervening grouping ranging from 91% to 99%.

For each of the first example (of the first histogram 300) and the second example (of the second histogram 350) a total number of 1,034 blocks arranged into the plurality of valid count groupings.

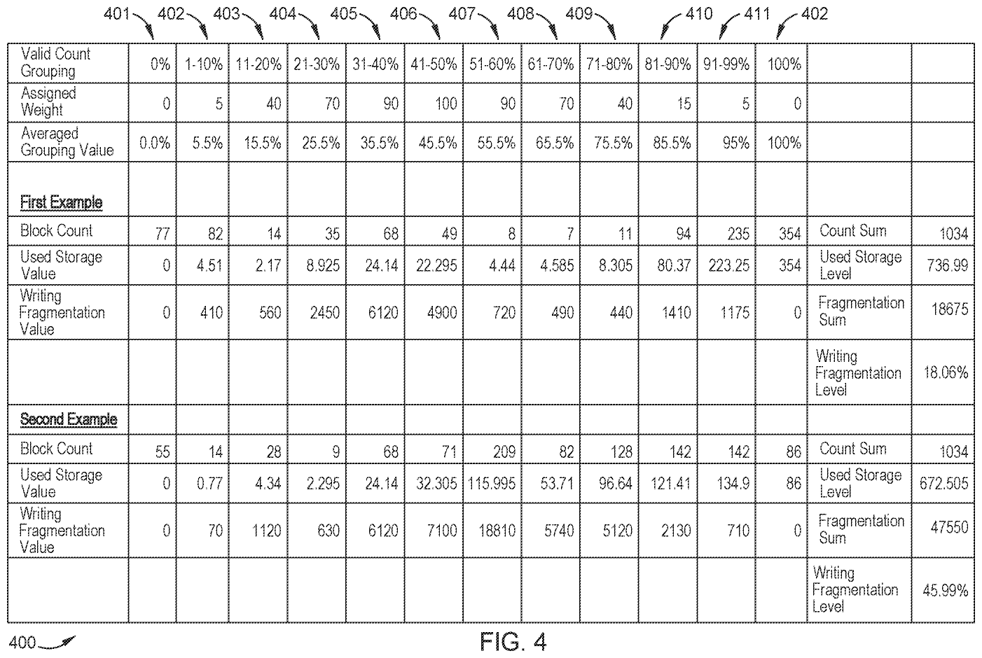

FIG. 4 is a schematic tabular view of a table 400, according to one implementation. The table 400 includes information shown in the first and second histograms 300, 350 shown in FIGS. 3A and 3B, and information determined using the information shown in the first and second histograms 300, 350.

For each of the first example and the second example the same plurality of valid count groupings were used.

In the implementation shown in FIG. 4, the plurality of assigned weights include the first minimal weight of zero assigned to the lower end grouping 401, the second minimal weight of zero assigned to the upper end grouping 402, the maximal weight of 100 assigned to the intermediate intervening grouping 406. The plurality of assigned weights include the first set of intervening weights assigned to the first subset 402-405 of the plurality of intervening groupings between the lower end grouping 401 and the intermediate intervening grouping 406. The plurality of assigned weights the second set of intervening weights assigned to the second subset 407-411 of the plurality of intervening groupings between the upper end grouping 402 and the intermediate intervening grouping 406.

The first set of intervening weights assigned to the first subset 402-405 range from 5 to 90 and decrease in value from 90 to 5. The second set of intervening weights assigned to the second subset 407-411 range from 5 to 90 and decrease in value from 90 to 5. The present disclosure contemplates that other values may be used for the plurality of assigned weights.

The present disclosure contemplates that different valid count groupings and assigned weights can be used than those used for the first example and the second example in FIG. 4. In one embodiment, which can be combined with other embodiments, the valid count groupings and the assigned weights are optimized, such as by using a machine learning model that is executed using the controller 108. In one example, which can be combined with other examples, the machine learning model is a regression model.

The present disclosure contemplates that narrower intervals may be used to increase data resolution, relative to the 10% and 9% intervals for the intervening groupings 402-411. In one embodiment, which can be combined with other embodiments, 5% intervals can be used for the intervening groupings between the lower end grouping 401 and the upper end grouping 402.

In the implementation shown in FIG. 4, the used storage level of 736.99 for the first example indicates a used storage percentage of 71.3% of the 1,034 total blocks, and the used storage level of 672.505 for the second example indicates a used storage percentage of 65% of the 1,034 total blocks. It is believed that the table 400 can be generated in relatively low processing time (such as 1 msec or less of processing (CPU) time).

The table 400 illustrates that, although the used storage level is lower for the second example (relative to the first example), the writing fragmentation level is higher for the second example.

Benefits of the present disclosure include providing broad fragmentation information in a simple and compact format; accurately determining writing fragmentation levels; simply and quickly determining writing fragmentation levels; shorter and simpler calculations, smaller and simpler information tables (such as table 400); enhanced housekeeping operation latency; enhance device performance; reduced hybrid usage; increased usage and compatibility of host-managed housekeeping operations; and smaller and simpler information graphics (such as histograms 300, 350). The benefits are facilitated in an efficient manner, such as for memory devices having 1,000 or more blocks, such as 2,000 or more blocks. It is believed that determining the writing fragmentation levels by accounting for the valid counts facilitates accurate determination of the writing fragmentation levels, and reduced or eliminated effects of capacity limits that would otherwise be present.

Device performance is enhanced by the reduced fragmentation as a data storage device involves several writing operations on a daily basis when in use by a host device. Using aspects described herein, a frequency at which the housekeeping operation is conducted is reduced because the method 200 facilitates maintaining a sufficient number of blocks open for writing operations. The present disclosure also facilitates a reduced write amplification factor (WAF) for writing operations and an increased storage lifetime for writing operations.

It is contemplated that one or more aspects disclosed herein may be combined. Moreover, it is contemplated that one or more aspects disclosed herein may include some or all of the aforementioned benefits. As an example, operations, aspects, components, features, and/or properties of the storage system 100, the method 200, the first histogram 300, the second histogram 350, and/or the table 400 may be combined.

In one embodiment, a data storage device includes one or more memory devices that include a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings to determine a plurality of block counts corresponding to the plurality of valid count groupings. The controller is configured to multiply the plurality of block counts by a plurality of assigned weights to determine a plurality of writing fragmentation values. The controller is also configured to sum together the plurality of writing fragmentation values to determine a fragmentation sum, sum together the plurality of block counts to determine a count sum, and divide the fragmentation sum by the count sum to determine a writing fragmentation level. The controller is also configured to initiate a housekeeping operation if the writing fragmentation level is at or above a threshold level. Each block count of the plurality of block counts is a number of blocks having a valid count of the plurality of valid counts that is within a respective valid count grouping of the plurality of valid count groupings. Each valid count of the plurality of valid counts is a used data storage percentage for a respective block of the plurality of blocks. The plurality of valid count groupings includes a lower end grouping of 0%, an upper end grouping of 100%, and a plurality of intervening groupings. The plurality of intervening groupings are intervals between 0% and 100%. At least some of the intervals are 10% intervals. The plurality of valid count groupings includes an intervening hybrid grouping ranging from 32.5% to 33.5%. The plurality of valid counts is arranged into a histogram having the plurality of block counts and the plurality of valid count groupings.

In one embodiment, a data storage device includes one or more memory devices that include a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings of a histogram to determine a plurality of block counts corresponding to the plurality of valid count groupings. Each block count of the plurality of block counts is a number of blocks having a valid count of the plurality of valid counts that is within a respective valid count grouping of the plurality of valid count groupings. The controller is configured to multiply the plurality of block counts by a plurality of assigned weights to determine a plurality of writing fragmentation values, and sum together the plurality of writing fragmentation values to determine a fragmentation sum. The controller is configured sum together the plurality of block counts to determine a count sum, and divide the fragmentation sum by the count sum to determine a writing fragmentation level. The controller is also configured to multiply the plurality of block counts by a plurality of averaged grouping values corresponding to the plurality of valid count groupings to determine a plurality of used storage values. The controller is also configured to generate a fragmentation report. The fragmentation report includes an alert if the writing fragmentation level is within a fragmentation range or a write amplification factor (WAF) of the fragmentation report is within a WAF range. The plurality of valid count groupings includes a lower end grouping of 0%, an upper end grouping of 100%, and a plurality of intervening groupings. The plurality of intervening groupings are intervals between 0% and 100%. The plurality of intervening groupings includes an intermediate intervening grouping. The intermediate intervening grouping ranges from 41% to 50%. The plurality of assigned weights includes a first minimal weight assigned to the lower end grouping, a second minimal weight assigned to the upper end grouping, a maximal weight assigned to the intermediate intervening grouping, and a first set of intervening weights assigned to a first subset of the plurality of intervening groupings between the lower end grouping and the intermediate intervening grouping. The first set of intervening weights decrease in value in a direction from the maximal weight and toward the first minimal weight. The plurality of assigned weights includes a second set of intervening weights assigned to a second subset of the plurality of intervening groupings between the upper end grouping and the intermediate intervening grouping. The second set of intervening weights decrease in value in a direction from the maximal weight and toward the second minimal weight. The first minimal weight is zero, the second minimal weight is zero, and the maximal weight is 100. The first set of intervening weights range from 5 to 90, and the second set of intervening weights range from 5 to 90. The controller is also configured to identify one or more hybrid blocks. The identifying of one or more hybrid blocks includes repeating the determining a plurality of valid counts of the plurality of blocks, and repeating the arranging the plurality of valid counts of the plurality of blocks into a plurality of valid count groupings of a histogram to determine a plurality of block counts. The identifying of one or more hybrid blocks includes determining if a block count corresponding to an intervening grouping has increased, the intervening grouping ranging from 31% to 40%.

In one embodiment, a data storage device includes one or more memory storage means that includes a plurality of blocks having data written to the plurality of blocks, and a controller coupled to the one or more memory devices. The controller is configured to determine a plurality of valid counts of the plurality of blocks, and arrange the plurality of valid counts of the plurality of blocks into a plurality of valid count groupings to determine a plurality of block counts corresponding to the plurality of valid count groupings. The controller is configured to multiply the plurality of block counts by a plurality of assigned weights to determine a plurality of writing fragmentation values.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
one or more memory devices comprising a plurality of blocks having data written to the plurality of blocks; and
a controller coupled to the one or more memory devices, wherein the controller is configured to:
determine a plurality of valid counts of the plurality of blocks,
arrange the plurality of valid counts of the plurality of blocks into a plurality of valid count groupings to determine a plurality of block counts corresponding to the plurality of valid count groupings, and
multiply the plurality of block counts by a plurality of assigned weights to determine a plurality of writing fragmentation values.

2. The data storage device of claim 1, wherein the controller is further configured to:
sum together the plurality of writing fragmentation values to determine a fragmentation sum;
sum together the plurality of block counts to determine a count sum; and
divide the fragmentation sum by the count sum to determine a writing fragmentation level.

3. The data storage device of claim 2, wherein the controller is further configured to:
initiate a housekeeping operation if the writing fragmentation level is at or above a threshold level.

4. The data storage device of claim 1, wherein each block count of the plurality of block counts is a number of blocks having a valid count of the plurality of valid counts that is within a respective valid count grouping of the plurality of valid count groupings.

5. The data storage device of claim 4, wherein each valid count of the plurality of valid counts is a used data storage percentage for a respective block of the plurality of blocks.

6. The data storage device of claim 5, wherein the plurality of valid count groupings comprises:
a lower end grouping of 0%;
an upper end grouping of 100%; and
a plurality of intervening groupings, wherein the plurality of intervening groupings are intervals between 0% and 100%.

7. The data storage device of claim 6, wherein at least some of the intervals are 10% intervals.

8. The data storage device of claim 6, wherein the plurality of valid count groupings comprises an intervening hybrid grouping ranging from 32.5% to 33.5%.

9. The data storage device of claim 1, wherein the plurality of valid counts is arranged into a histogram having the plurality of block counts and the plurality of valid count groupings.

10. A data storage device, comprising:
one or more memory devices comprising a plurality of blocks having data written to the plurality of blocks; and
a controller coupled to the one or more memory devices, wherein the controller is configured to:
determine a plurality of valid counts of the plurality of blocks,
arrange the plurality of valid counts of the plurality of blocks into a plurality of valid count groupings of a histogram to determine a plurality of block counts corresponding to the plurality of valid count groupings, wherein each block count of the plurality of block counts is a number of blocks having a valid count of the plurality of valid counts that is within a respective valid count grouping of the plurality of valid count groupings,
multiply the plurality of block counts by a plurality of assigned weights to determine a plurality of writing fragmentation values,
sum together the plurality of writing fragmentation values to determine a fragmentation sum,
sum together the plurality of block counts to determine a count sum, and
divide the fragmentation sum by the count sum to determine a writing fragmentation level.

11. The data storage device of claim 10, wherein the controller is further configured to:
multiply the plurality of block counts by a plurality of averaged grouping values corresponding to the plurality of valid count groupings to determine a plurality of used storage values.

12. The data storage device of claim 10, wherein the controller is further configured to:
generate a fragmentation report, the fragmentation report comprising an alert if the writing fragmentation level is within a fragmentation range or a write amplification factor (WAF) of the fragmentation report is within a WAF range.

13. The data storage device of claim 10, wherein the plurality of valid count groupings comprises:
a lower end grouping of 0%;
an upper end grouping of 100%; and
a plurality of intervening groupings, wherein the plurality of intervening groupings are intervals between 0% and 100%.

14. The data storage device of claim 13, wherein the plurality of intervening groupings comprises a intermediate intervening grouping.

15. The data storage device of claim 14, wherein the intermediate intervening grouping ranges from 41% to 50%.

16. The data storage device of claim 14, wherein the plurality of assigned weights comprises:
a first minimal weight assigned to the lower end grouping;
a second minimal weight assigned to the upper end grouping;
a maximal weight assigned to the intermediate intervening grouping;
a first set of intervening weights assigned to a first subset of the plurality of intervening groupings between the lower end grouping and the intermediate intervening grouping, the first set of intervening weights decreasing in value in a direction from the maximal weight and toward the first minimal weight; and
a second set of intervening weights assigned to a second subset of the plurality of intervening groupings between the upper end grouping and the intermediate intervening grouping, the second set of intervening weights decreasing in value in a direction from the maximal weight and toward the second minimal weight.

17. The data storage device of claim 16, wherein the first minimal weight is zero, the second minimal weight is zero, and the maximal weight is 100.

18. The data storage device of claim 17, wherein the first set of intervening weights range from 5 to 90, and the second set of intervening weights range from 5 to 90.

19. The data storage device of claim 10, wherein the controller is further configured to identify one or more hybrid blocks, the identifying of one or more hybrid blocks comprising:
repeating the determining a plurality of valid counts of the plurality of blocks;
repeating the arranging the plurality of valid counts of the plurality of blocks into a plurality of valid count groupings of a histogram to determine a plurality of block counts; and
determining if a block count corresponding to an intervening grouping has increased, the intervening grouping ranging from 31% to 40%.

20. A data storage device, comprising:
one or more memory storage means comprising a plurality of blocks having data written to the plurality of blocks; and
a controller coupled to the one or more memory storage means, wherein the controller is configured to:
determine a plurality of valid counts of the plurality of blocks,
arrange the plurality of valid counts of the plurality of blocks into a plurality of valid count groupings to determine a plurality of block counts corresponding to the plurality of valid count groupings, and
multiply the plurality of block counts by a plurality of assigned weights to determine a plurality of writing fragmentation values.
